(19) United States
(12) Patent Application Publication
(10) Pub. No.: US 2014/0257742 A1
(43) Pub. Date: Sep. 11, 2014

(54) METHOD TO STRUCTURE MINERAL AGGREGATE GRADATION BY USING THREE CONTROL POINTS AND TWO CURVES

(71) Applicants: GUANGXI COMMUNICATIONS INVESTMENT GROUP CO., LTD., Guangxi (CN); RESEARCH INSTITUTE OF HIGHWAY, MOT, PRC, Beijing (CN)

(72) Inventors: Xudong Wang, Beijing (CN); Qin Fu, Guangxi (CN); Lei Zhang, Beijing (CN); Yi Liu, Nanning (CN); Xingye Zhou, Beijing (CN); Fujian Li, Beijing (CN)

(73) Assignees: RESEARCH INSTITUTE OF HIGHWAY, MOT, PRC, Beijing (CN); GUANGXI COMMUNICATIONS INVESTMENT GROUP CO., LTD., Guangxi (CN)

(21) Appl. No.: 14/348,843

(22) PCT Filed: Oct. 15, 2012
(86) PCT No.: PCT/CN2012/082989

§ 371 Date: Mar. 31, 2014

(30) Foreign Application Priority Data
Oct. 15, 2011 (CN) 201110313053.5

(51) Int. Cl. G06F 17/10; G01N 9/36

(52) U.S. Cl. CPC G06F 17/10; G01N 9/36
USPC 702/137; 702/127

(57) ABSTRACT

The invention involves “a method to structure mineral aggregate gradation by using three control points & two curves”, including the following steps: (1) Three control points are determined according to the property of the mixtures: nominal maximum size of aggregate and its passing rate, nominal minimum size of aggregate and its passing rate, and the discontinuity point between the coarse aggregate and the fine aggregate and its passing rate. (2) The grading curves of the coarse and the fine aggregate are selected respectively with Power function model, Exponential function model and Logarithmic function model. (3) Measure the stamped density and the stamped voids in mineral aggregate, and then choose the grading of the coarse and the fine aggregate on the basis of the project need. The invention can help constitute different gradation curves in line with local materials from different areas and sources. In this way can the mineral aggregate's property give the full play to the mixtures, and it's a good guide to the mix proportion of the asphalt mixture.

### TECHNICAL FIELD

The invention involves a method determining the grading of the asphalt mixture, especially involving the method to structure mineral aggregate gradation by using three control points & two curves.

### TECHNICAL BACKGROUND

Mineral aggregate gradation is composed of a variety of different grades of ore material and it's very complex to determine the reasonable proportion between efferent particle sizes of the ore material in practical engineering. Predefining a gradation curve or a gradation range and applying to different particle sizes of ore materials are the starting point of common graduation design. Those can't make full use of technical feature of different particle sizes of ore materials and also cause our blindness to the graduation design.

For example; basalts in Beijing, basalts in Hebei, rolling pebbles in Sichuan and granites in Guangdong are selected to make a Marshall compaction test according to the same graduation curve (shown in table 1). The results show that the voids of the mixtures with the same graduation and the same asphalt aggregate ratio vary widely from the minimum 3.84% to the maximum 6.80%. Further, the particle size analysis of the 4.75 mm-9.5 mm coarse aggregates which account for more than 60% of the total mixture weight indicates that the coarse aggregate particle size of stone vary widely (shown in table 2). These results show that the density degrees of the asphalt mixtures with the same graduation are different because of various raw material properties. Therefore some effective methods should be made to control the mixture graduation combining with the raw material properties.

TABLE 1
Marshall test of different coarse aggregates

| Stone source | Density | Void ratio | VMA | VFA | VCA |
|---|---|---|---|---|---|
| Beijing | 2.5261 | 3.84% | 13.57% | 71.73% | 44.09% |
| Guangdong | 2.3167 | 6.80% | 15.71% | 56.72% | 44.53% |
| Sichuan | 2.4005 | 5.08% | 14.54% | 65.07% | 44.09% |
| Hebei | 2.4433 | 6.65% | 17.07% | 61.07% | 46.53% |

TABLE 2
Equivalent radius of different coarse aggregates

| STONE SOURCE | Beijing | Guangdong | Sichuan | Hebei |
|---|---|---|---|---|
| equivalent radius of | 0.38 | 0.41 | 0.41 | 0.46 |
| coarse aggregates(cm) | | | | |

How to select a proper gradation curve according to the condition of the material property? This is the key point of the patent. Nowadays there are three widely recognized methods to structure a grading curve:

The first is called Method N, which is presented by Talbol's formula on the basis of the principle of maximum density.

$${P}_{i} = 100 {( \frac{{d}_{i}}{D} )}^{n}$$

Pᵢ—passing rate of the particle dᵢ%
dᵢ—the different levels of the particle size (mm)
D—the maximum particle size of the mixture (mm)

Usually n=0.3-0.7, Filler Curve n=0.5, n=0.45 recommended in Japan and Standard grading basis in America n=0.45.

The second is called Method I by Professor Lin Xiuxian from Tongji University in 1970s. The method takes i, the declining rate of the passing rate, as the parameter of the grading design.

Pₓ=100×i^{x}
i—the declining rate of the passing rate,
d—the different levels of the particle size (mm).
D—the maximum particle size of the mixture (mm)
The reasonable range of i is 0.7-0.8. The fine aggregate is over if i>0.8, and the mixture is easily permeable if i<0.7. It is optimum when i=0.75.

The third method is called Method K by former Soviet Union with controlling the declining coefficient of the residue on sieve.

y=3.32 lg(D/0.004)

x=3.32 lg(D/d)

k—the declining coefficient of particle sizing weight
d—the different levels of the particle size (mm)
x—the amount of aggregate classification

It's reasonable when k=0.7-0.8 by Tongji University, k=0.7 in the south of China, while k==0.75 in the north of China. Rutting may happen easily if i>0.8.

TABLE 3
the difference of the design grading from different design methods

| Particle size (mm) | | 19 | 16 | 13.2 | 9.5 | 4.75 | 2.36 | 1.18 | 0.6 | 0.3 | 0.15 | 0.075 |
|---|---|---|---|---|---|---|---|---|---|---|---|---|
| Method N | n = 0.3 | 100.0 | 95.0 | 89.6 | 81.2 | 66.0 | 53.5 | 43.4 | 35.5 | 28.8 | 23.4 | 19.0 |
| | n = 0.4 | 100.0 | 93.4 | 86.4 | 75.8 | 57.4 | 43.4 | 32.9 | 25.1 | 19.0 | 14.4 | 10.9 |
| | n = 0.5 | 100.0 | 91.8 | 83.4 | 70.7 | 50.0 | 35.2 | 24.9 | 17.8 | 12.6 | 8.9 | 6.3 |
| | n = 0.6 | 100.0 | 90.2 | 80.4 | 66.0 | 43.5 | 28.6 | 18.9 | 12.6 | 8.3 | 5.5 | 3.6 |
| | n = 0.7 | 100.0 | 88.7 | 77.5 | 61.6 | 37.9 | 23.2 | 14.3 | 8.9 | 5.5 | 3.4 | 2.1 |
| | n = 0.45 | 100.0 | 92.6 | 84.9 | 73.2 | 53.6 | 39.1 | 28.6 | 21.1 | 15.5 | 11.3 | 8.3 |
| Method I | i = 0.7 | 100.0 | 91.5 | 82.9 | 70.0 | 49.0 | 34.2 | 24.0 | 16.9 | 11.8 | 8.3 | 5.8 |
| | i = 0.75 | 100.0 | 93.1 | 86.0 | 75.0 | 56.3 | 42.1 | 31.6 | 23.9 | 17.9 | 13.4 | 10.1 |
| | i = 0.8 | 100.0 | 94.6 | 88.9 | 80.0 | 64.0 | 51.1 | 40.9 | 32.9 | 26.3 | 21.1 | 16.9 |
| Method K | k = 0.7 | 100.0 | 91.4 | 82.7 | 69.6 | 48.3 | 33.3 | 22.9 | 15.7 | 10.6 | 7.0 | 4.5 |
| | k = 0.75 | 100.0 | 92.9 | 85.5 | 74.2 | 54.8 | 40.2 | 29.3 | 21.3 | 15.2 | 10.6 | 7.1 |
| | k = 0.8 | 100.0 | 94.2 | 88.1 | 78.5 | 61.3 | 47.5 | 36.5 | 27.9 | 20.8 | 15.2 | 10.7 |

The common feature of these methods is using a single grading curve to define the composition of each particle size and therefore the option of the grading is limited because of not reflecting the grading property of the raw materials.

### Invention Content

1. A method to structure mineral aggregate graduation by using three control points-two curves includes the following steps:
   1) Three control points are determined according to the properties of the mixtures: nominal maximum size of aggregate and its passing rate, nominal minimum size (0.075 mm) of aggregate and its passing rate, the discontinuity point between the coarse aggregate and the fine aggregate (4.75 mm) and its passing rate.
   2) The grading curves of the coarse and the fine aggregate are selected respectively with Power function model, Exponential function model and Logarithmic function model.

Power function model:

y=a·x^{b}

Exponential function model:

y=a·e^{bx}

Logarithmic function model:

y=a·ln(x)+b

a,b: undetermined parameters

y: passing rate of the particle size

x: aperture size
3) Measure the stamped density and the stamped voids in mineral aggregate, and then choose the grading of the coarse and the fine aggregate.
2. According to the method mentioned in the claims 1, the bulk density of asphalt mixtures, the void content, the voids in mineral aggregate and the voids in coarse aggregate are included.
3. According to the method mentioned in the claims 1, Marshall compaction test is used to measure the bulk density of asphalt mixtures, the void content, the voids in mineral aggregate and the voids in coarse aggregate.
4. According to the method mentioned in the claims 1, the discontinuity point passing rate of the dense mixture is more than 30%, that of the skeleton mixture is less than 40% and that of the open-graded mixture is between 15% and 25%.
   The specific steps of the invention are as follows:

The invention point 1: the method of “three control points & two curves” graduation constitute is presented. In the plane coordinates of the mineral aggregate size and passing rate, the first control point is nominal maximum size of aggregate and its passing rate, and the second one is the minimum size (0.075 mm) of aggregate and its passing rate, and the third one is the discontinuity point between the coarse aggregate and the fine aggregate (4.75 mm) and its passing rate. The whole mineral aggregate gradation is divided into coarse aggregate gradation and fine aggregate gradation curves by these three control points. The coarse aggregate gradation curve means the curve which ranges from the nominal maximum size of aggregate to the discontinuity point between the coarse aggregate and the fine aggregate and the fine aggregate gradation curve means the curve which ranges from the discontinuity point between the coarse and the fine aggregate to the minimum size of aggregate. (shown in FIG. 1)

The invention point 2: The grading curves of the coarse and the fine aggregate are selected respectively with Power function model, Exponential function model and Logarithmic function model. Thus two curves respectively have the mineral aggregate gradation of the coarser, the finer and the medium, which is beneficial to the option of mineral aggregate gradation. There are nine test gradation curves after combination and one can be selected after test as a suitable design curve.
Power function model:

y=a·x^{b}
Exponential function model:

y=a·e^{bx}
Logarithmic function model:

y=a·ln(x)+b
a, b: undetermined parameters
y: passing rate of the particle size
x: aperture size

The corresponding coarse aggregate-fine aggregate function model are Exponential function-Exponential function, Exponential function-Power function, Exponential function-Logarithmic function, Power function-Exponential function, Power function-Power function, Power function-Logarithmic function, Logarithmic function-Exponential function, Logarithmic function-Power function, Logarithmic function-Logarithmic function.

The invention 3: the gradation is determined through the performance test on the basis of the project need.

The passing rate of the discontinuity point between the coarse aggregate and the fine aggregate is adjustable. Besides controlling the run of the whole mineral aggregate gradation through the selection of the theoretical gradation curve, the constitution trend of the gradation curve can be controlled by the passing rate of the discontinuity point between the coarse and the fine aggregate. The passing rate of the discontinuity point has an important impact on some key indicators such as density. The discontinuity point passing rate of the dense mixture is more than 30%, that of the skeleton mixture is less than 40% and that of the open-graded mixture is between 15% and 25%.

Mineral aggregate gradation is composed of a variety of different grades of ore material, and in theory the countless curves can be built between the two key points in accordance with any law. Although these three models own the same key points, the proportion of each particle size's aggregates is so different that the discrepancy of pavement performance is obvious.

The “three control points & two curves” gradation option method raised in the gradation design of the asphalt mixture can select the optimized gradation clearer and more quickly. The mixture of dense, half open-graded and open-graded can be made in line with the request of asphalt mixture's mix proportion. Then through the analysis of the performance of these mixtures, a suitable gradation can be selected on the basis of the project demand.

The invention can help constitute different gradation curves in line with local materials from different areas and sources. In this way can the mineral aggregate's performance give the full play to the mixtures, and it's a good guide to the mix proportion of the asphalt mixture.

### FIGURE LEGENDS

FIG. 1: Key elements of mineral aggregate gradation design

FIG. 2: Coarse gradation curve of three math function models

FIG. 3: Comparison of mixture's bulk density from three gradations

FIG. 4: Comparison of mixture's void content from three gradations

FIG. 5: Comparison of mixture's voids in mineral aggregates (VMA) from three gradations

FIG. 6: Comparison of mixture's voids in coarse aggregates from three gradations

FIG. 7: Comparison of mixture's saturation from three gradations

FIG. 8: gradation curve in the test

### SPECIFIC IMPLEMENTATION METHODS

The detail description of the invention combined with example is as follows.

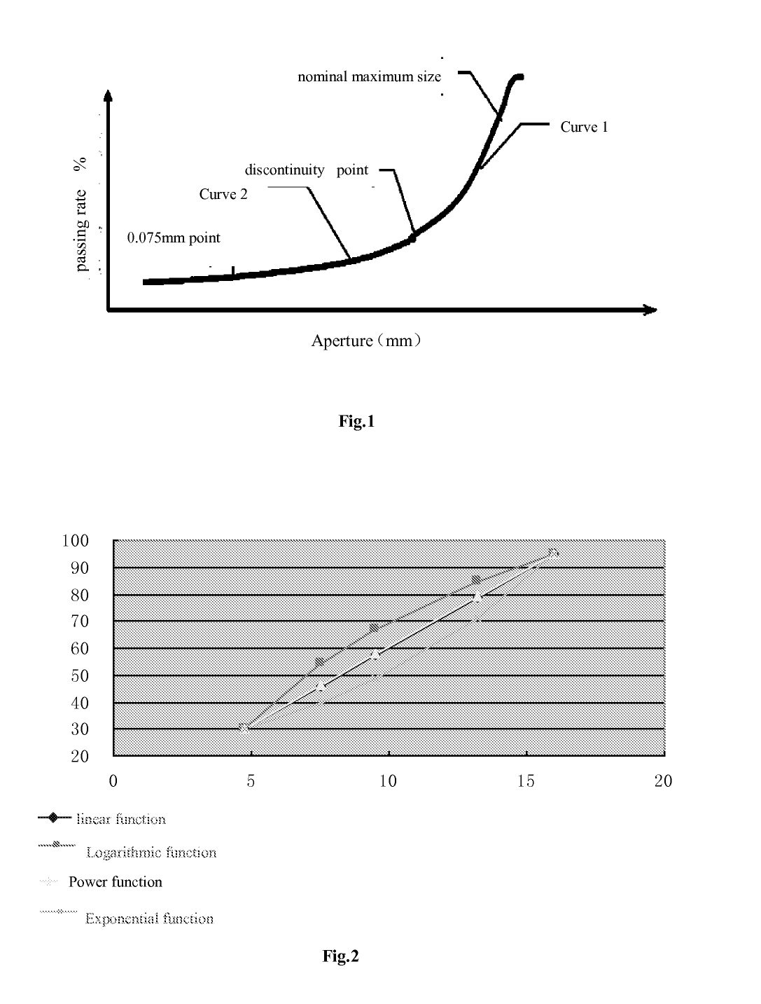

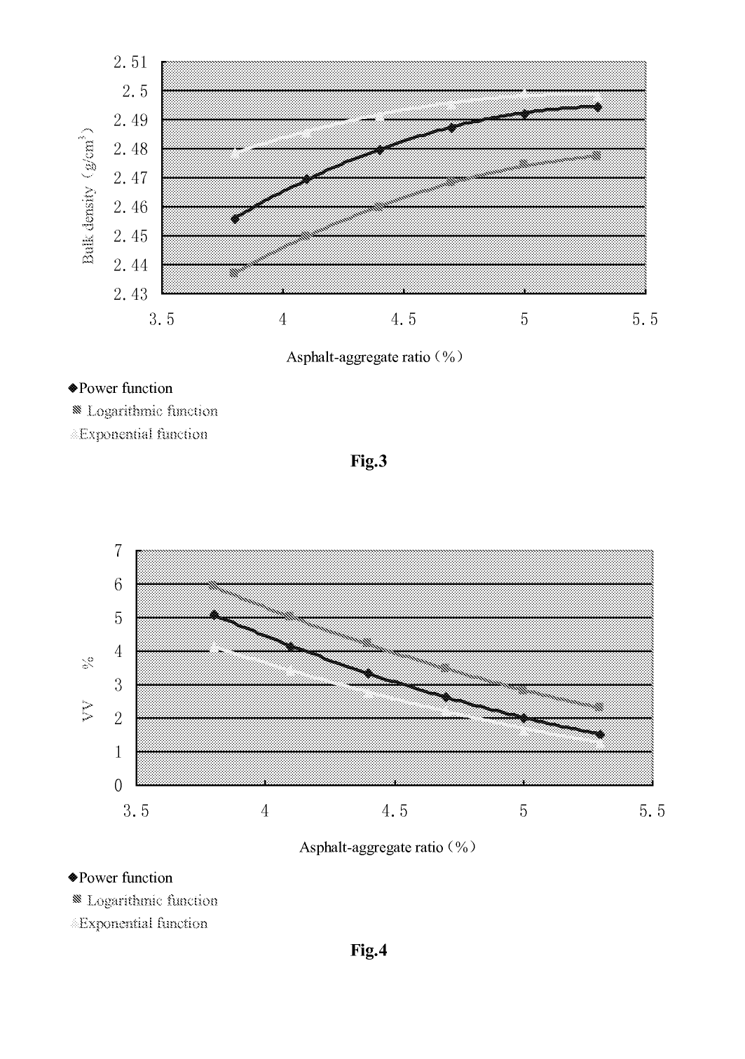

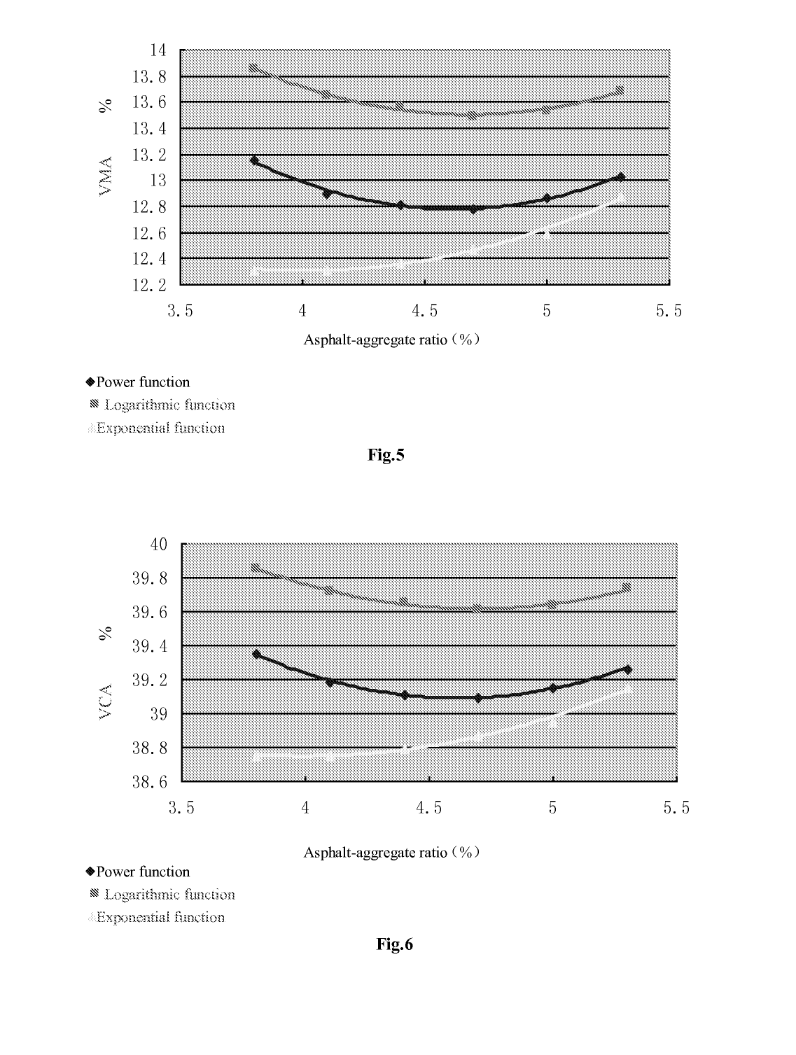

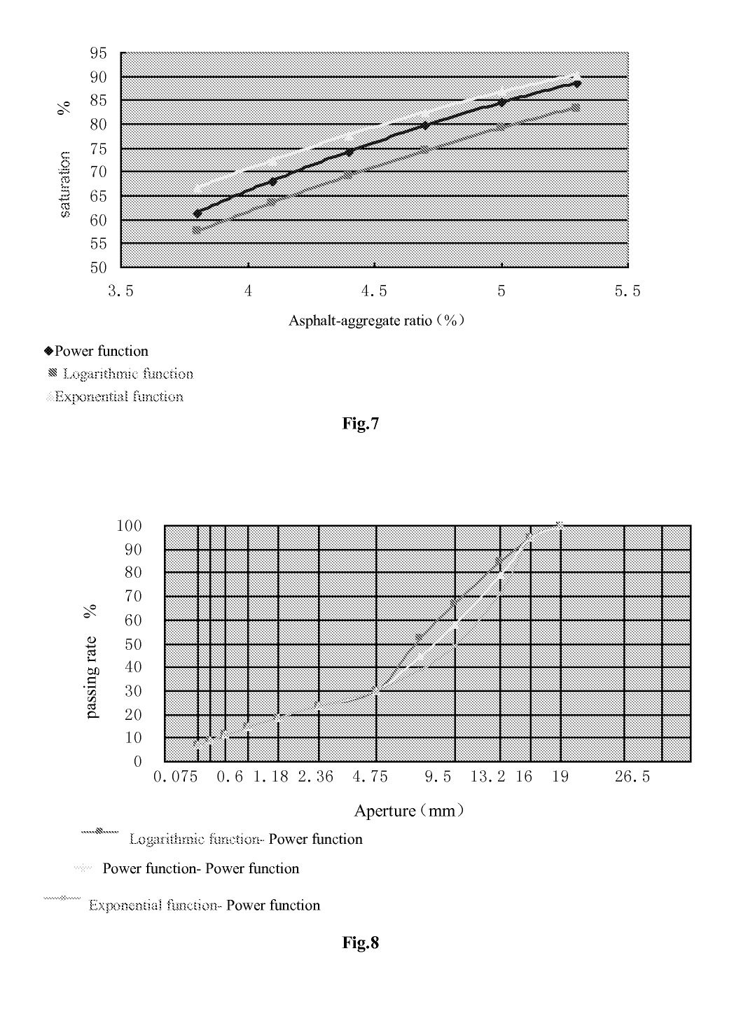

Taking a “Type 16” mixture for example, its based on the principal of the skeleton broken gradation, and the passing rate of 16 mm particle size is 95% and that of 4.75 mm is 30%, and that of 0.075 mm is 7%. These three points are selected as control points and the coarse and fine aggregate gradation curves can be respectively made up with Exponential function, Logarithmic function and Power function. According to the orthogonal test different fine or coarse aggregate curves can be determined, but only the impact of the change in the coarse aggregate mix proportion is considered in this technical proposal. Therefore the 4.75 mm-0.075 mm fine aggregate curve generates with power function and 16 mm-4.75 mm coarse aggregate curves generate with Exponential function model, Logarithmic function model and Power function model. Three gradation curves of “Type 16” mixture are shown in Table 4 and FIGS. 2,8

TABLE 4
Corresponding gradation result of three function models in the invention

| Function type | | | | | | | | | | | | |
|---|---|---|---|---|---|---|---|---|---|---|---|---|
| of the coarse | | | | | | | | | | | | |
| aggregate | 19 | 16 | 13.2 | 9.5 | 7.5 | 4.75 | 2.36 | 1.18 | 0.6 | 0.3 | 0.15 | 0.075 |
| Logarithmic | 100 | 95 | 84.7 | 67.1 | 54.4 | 30 | 22.9 | 17.5 | 13.4 | 10.3 | 7.9 | 6 |
| function | | | | | | | | | | | | |
| Power | 100 | 95 | 79.1 | 57.9 | 46.3 | 30 | 22.9 | 17.5 | 13.4 | 10.3 | 7.9 | 6 |
| function | | | | | | | | | | | | |
| [symbol] | 100 | 95 | 71.3 | 48.8 | 39.8 | 30 | 22.9 | 17.5 | 13.4 | 10.3 | 7.9 | 6 |
| [symbol] | | | | | | | | | | | | |
| [symbol] | | | | | | | | | | | | |
| function | | | | | | | | | | | | |

As shown in Table 4, the coarse aggregate gradation curve with power function is similar with that of linear function. The coarse aggregate gradation curve with log function is finer with that of power function. The coarse aggregate gradation curve with exponential function is coarser than that of power function. The performance analysis of the asphalt mixture with these three kinds of gradation is as follows.

The density of the aggregate and mineral powder is shown is Chart 5

TABLE 5
The density of the aggregate and mineral powder

| | Saturated surface- | Apparent | Bulk | Water |
|---|---|---|---|---|
| | dry density | density | density | absorption |
| 16 | 2.7370 | 2.7520 | 2.7285 | 0.31% |
| 13.2 | 2.7359 | 2.7519 | 2.7268 | 0.33% |
| 9.5 | 2.7338 | 2.7524 | 2.7232 | 0.39% |
| 4.75 | 2.7626 | 2.8055 | 2.7388 | 0.87% |
| 2.36 | 2.6875 | 2.7258 | 2.6653 | 0.83% |
| 1.18 | 2.6880 | 2.7259 | 2.6660 | 0.82% |
| 0.6 | 2.6805 | 2.7205 | 2.6573 | 0.87% |
| 0.3 | 2.6894 | 2.7191 | 2.6722 | 0.65% |
| 0.15 | | 2.7326 | | |
| 0.075 | | 2.7714 | | |
| Mineral | | 2.8303 | | |
| powder | | | | |

The theoretical density of these three mixtures in different asphalt-aggregate ratios is calculated by the average of the apparent density and bulk density. At the same time the coarse aggregate's bulk density and mineral aggregate's bulk density of these three kinds of gradation can be also calculated, shown in Table 6.

TABLE 6
The result of density calculation from mixtures of three function models gradation

| Asphalt- | | | | | | | coarse | mineral |
|---|---|---|---|---|---|---|---|---|
| aggregate | theoretical density | | | | | | aggregate's bulk | aggregate's bulk |
| ratio | 3.8% | 4.1% | 4.4% | 4.7% | 5% | 5.3% | density | density |
| Power | 2.5869 | 2.5756 | 2.5646 | 2.5537 | 2.5429 | 2.5323 | 2.7301 | 2.7236 |
| gradation | | | | | | | | |
| Logarithmic | 2.5897 | 2.5785 | 2.5674 | 2.5564 | 2.5457 | 2.5350 | 2.7323 | 2.7251 |
| gradation | | | | | | | | |
| Exponential | 2.5846 | 2.5734 | 2.5624 | 2.5515 | 2.5408 | 2.5302 | 2.7290 | 2.7228 |
| gradation | | | | | | | | |

The stamped density and the VCA of the three gradation mixtures is shown in Table 7. The result indicates that the sequence decreasingly of the stamped density is exponential gradation, power gradation and logarithmic gradation, and the stamped VCA has the opposite result.

TABLE 7
the result of stamped density and VCA from
mixtures of three function models gradation

| Function model | Stamped density (g/cm³ ) | Stamped VCA |
|---|---|---|
| Power function | 1.6820 | 38.39% |
| Logarithmic function | 1.6804 | 38.50% |
| Exponential function | 1.6891 | 38.11% |

CHART 8
Marshall compaction test of the mixtures of three
function models gradation(75times for each side)

| | | | | | | | | |
|---|---|---|---|---|---|---|---|---|
| Asphalt- | Bulk | Theoretical | | | | | | Dry |
| aggregate | density | density | VV | VMA | VA | VFA | VCA | density |
| ratio (%) | (g/cm³) | (g/cm³) | (%) | (%) | (%) | (%) | (%) | (g/cm³) |

Power function model

| | | | | | | | | |
|---|---|---|---|---|---|---|---|---|
| 3.8 | 2.4555 | 2.5869 | 5.08 | 13.15 | 8.07 | 61.36 | 39.35 | 2.3656 |
| 4.1 | 2.4695 | 2.5756 | 4.12 | 12.9 | 8.78 | 68.05 | 39.18 | 2.3722 |
| 4.4 | 2.4793 | 2.5646 | 3.33 | 12.81 | 9.48 | 74.03 | 39.11 | 2.3748 |
| 4.7 | 2.4871 | 2.5537 | 2.61 | 12.78 | 10.18 | 79.61 | 39.09 | 2.3755 |
| 5 | 2.492 | 2.5429 | 2.00 | 12.86 | 10.86 | 84.42 | 39.15 | 2.3733 |
| 5.3 | 2.4945 | 2.5323 | 1.50 | 13.02 | 11.53 | 88.51 | 39.26 | 2.3689 |

Logarithmic function model

| | | | | | | | | |
|---|---|---|---|---|---|---|---|---|
| 3.8 | 2.4369 | 2.5897 | 5.9 | 13.85 | 7.95 | 57.4 | 39.85 | 2.3477 |
| 4.1 | 2.4496 | 2.5785 | 5.00 | 13.65 | 8.65 | 63.38 | 39.72 | 2.3531 |
| 4.4 | 2.4593 | 2.5674 | 4.21 | 13.56 | 9.35 | 68.94 | 39.65 | 2.3556 |
| 4.7 | 2.4682 | 2.5564 | 3.45 | 13.49 | 10.04 | 74.41 | 39.61 | 2.3574 |
| 5 | 2.4741 | 2.5457 | 2.81 | 13.53 | 10.72 | 79.24 | 39.63 | 2.3563 |
| 5.3 | 2.477 | 2.535 | 2.29 | 13.68 | 11.39 | 83.27 | 39.73 | 2.3524 |

Exponential function model

| | | | | | | | | |
|---|---|---|---|---|---|---|---|---|
| 3.8 | 2.4784 | 2.5846 | 4.11 | 12.31 | 8.2 | 66.62 | 38.75 | 2.3877 |
| 4.1 | 2.4856 | 2.5734 | 3.41 | 12.31 | 8.9 | 72.28 | 38.75 | 2.3877 |
| 4.4 | 2.4913 | 2.5624 | 2.77 | 12.36 | 9.58 | 77.56 | 38.79 | 2.3863 |
| 4.7 | 2.4952 | 2.5515 | 2.21 | 12.47 | 10.27 | 82.31 | 38.87 | 2.3832 |
| 5 | 2.4991 | 2.5408 | 1.64 | 12.59 | 10.95 | 86.96 | 38.95 | 2.3801 |
| 5.3 | 2.4981 | 2.5302 | 1.27 | 12.87 | 11.6 | 90.14 | 39.15 | 2.3723 |

In comparison with these three kinds of gradation, at the same asphalt-aggregate ratio, the bulk density of the exponential model is the largest and the VV, VMA, VCA is the smallest, and the VFA is the largest. The bulk of the logarithmic function is the smallest, and the VV, VMA,VCA is the largest, and the VFA is the smallest. The power function model lies between the other models. The compaction of mixture with the exponential model is the best, and that of the logarithmic model is the worst and that of the power function lies between them. The results agree with the stamped VCA test result, which means the coarse aggregate stamped test do help to the forecast of the mixture's volume performance.

Based on the design void content, the asphalt-aggregate ratio of the exponential model is 3.85%, 4.13% for power model, and 4.50% for the logarithmic model.

The test results show that the performance of the mixtures is obviously influenced by different coarse aggregate gradations even with the same raw material or the same gravel content. In the real project, after the gravel content of the mixture is determined, the gradation of the gravel (coarse aggregates) still need to be optimally designed to reach the best condition of the mixture.

Based on the feature of the three coarse aggregate gradation, the content of the coarse aggregate with the exponential function is larger, which may lead to a larger texture depth and a better skid-resistant performance, however the only weakness is the separation in the construction which may require a higher technological level of the paving construction. While the content of the coarse aggregate with the logarithmic function is smaller, which may leads to a weak skid resistant performance but a easy construction. The power function lies between them.

The “three control points-two curves” gradation option method raised in the gradation design of the asphalt mixture can select the optimized gradation clearer and more quickly. The mixture of dense, half open-graded and open-graded can be made in line with the request of asphalt mixture's mix proportion. Then through the analysis of the performance of these mixtures, a suitable gradation can be selected on the basis of the project demand.

1. A method to structure mineral aggregate gradation by using three control points-two curves includes the following steps:
1) Three control points are determined according to the properties of the mixtures: nominal maximum size of aggregate and its passing rate, nominal minimum size (0.075 mm) of aggregate and its passing rate, the discontinuity point between the coarse aggregate and the fine aggregate (4.75 mm) and its passing rate.
2) The grading curves of the coarse and the fine aggregate are selected respectively with Power function model, Exponential function model and Logarithmic function model.
Power function model:
y=a·x^{b}
Exponential function model:
y=a·e^{bx}
Logarithmic function model:
y=a·ln(x)+b
a,b: undetermined parameters
Y: Passing rate of the particle size
X: Aperture size
3) Measure the stamped density and the stamped voids in mineral aggregate, and then choose the grading of the coarse and the fine aggregate.

2. According to the method mentioned in the claims 1, the bulk density of asphalt mixtures, the void content, the voids in mineral aggregate and the voids in coarse aggregate are included.

3. According to the method mentioned in the claims 1, Marshall compaction test is used to measure the bulk density of asphalt mixtures, the void content, the voids in mineral aggregate and the voids in coarse aggregate.

4. According to the method mentioned in the claims 1, the discontinuity point passing rate of the dense mixture is more than 30%, that of the skeleton mixture is less than 40% and that of the open-graded mixture is between 15% and 25%.
